(19) United States
(12) Patent Application Publication
(10) Pub. No.: US 2012/0043450 A1
(43) Pub. Date: Feb. 23, 2012

(54) ATTACHMENT ARRANGEMENT FOR A COLUMN HOLDER

(75) Inventor: Mats Lundkvist, Uppsala (SE)

(73) Assignee: GE HEALTHCARE BIO-SCIENCES AB, UPPSALA (SE)

(21) Appl. No.: 13/266,778

(22) PCT Filed: Apr. 23, 2010
(86) PCT No.: PCT/SE2010/050454

§ 371 Date: Oct. 28, 2011

(30) Foreign Application Priority Data
Apr. 28, 2009 (SE) 0950284-0

(51) Int. Cl. F16M 13/00; F16B 2/22

(52) U.S. Cl. 248/539; 248/231.81

(57) ABSTRACT

An attachment arrangement comprising—two resilient arms (1a, 1b) connected to a device to be attached, the other ends of the resilient arms (1a, 1b) pointing away from each other; —one locking part (7a, 7b) on each resilient arm (1a, 1b), said locking parts (7a, 7b) being T-shaped and adapted to together fit into a T-groove by forcing the resilient arms (1a, 1b) towards each other and twist the attachment arrangement during insertion into the T-groove. Said attachment arrangement is secured in the T-groove when the attachment arrangement is twisted back again and the pressure on the resilient arms (1a, 1b) is released. A column holder provided with an attachment arrangement according to the invention.

### CROSS-REFERENCE TO RELATED APPLICATIONS

This application is a filing under 35 U.S.C. §371 and claims priority to international patent application number PCT/SE2010/050454 filed Apr. 23, 2010, published on Nov. 4, 2010 as WO 2010/126433, which claims priority to application number 0950284-0 filed in Sweden on Apr. 28, 2009.

### FIELD OF THE INVENTION

The present invention relates to an attachment arrangement. Furthermore the present invention relates to a column holder comprising such an attachment arrangement.

### BACKGROUND OF THE INVENTION

For example in a chromatography system there can be a number of columns of different seizes that need to be securely hold and preferable they should be replaceable in an easy way. Usually columns are mounted in some kind of more or less unwieldy holder. Especially for small columns that need to be moved or replaced often there is a need for a more easily handled holder.

### SUMMARY OF THE INVENTION

One object of the invention is to provide an attachment arrangement that can be attached easily and be kept firmly in place. This is achieved with an attachment arrangement according to claim 1. Hereby the attachment arrangement can be easily attached in a T-groove. Because of the resilient arms pointing away from each other the attachment arrangement is also kept firmly in place in the T-groove and the attachment arrangement can easily be removed from the T-groove by just pressing the resilient arms together again and twist the attachment arrangement and remove it from the T-groove.

A further object of the invention is to provide a column holder that holds the column firmly in place and which can be easily removed from the system. This is achieved by a column holder according to claim 3. Hereby the column holder can be easily attached in a T-groove and also removed. Furthermore, as discussed above, the column holder will be held firmly in place in the T-groove when the resilient arms are released in the T-groove.

Suitably the whole column holder together with the attachment arrangement is injection moulded in one piece.

Further suitable embodiments of the invention are described in the depending claims.

### BRIEF DESCRIPTION OF THE DRAWINGS

FIG. 1 is a schematic view of the attachment arrangement according to one embodiment of the invention.

FIG. 2a-2d is a schematic view of the attachment arrangement according to the embodiment shown in FIG. 1 when it is being inserted into a T-groove.

FIG. 3 shows one embodiment of a column holder provided with an attachment arrangement according to the invention.

FIG. 4 shows another embodiment of a column holder provided with an attachment arrangement according to the invention.

### DETAILED DESCRIPTION OF THE INVENTION

According to the invention an attachment arrangement adapted to fit into a T-groove is provided. Also according to the invention a column holder provided with such an attachment arrangement is provided.

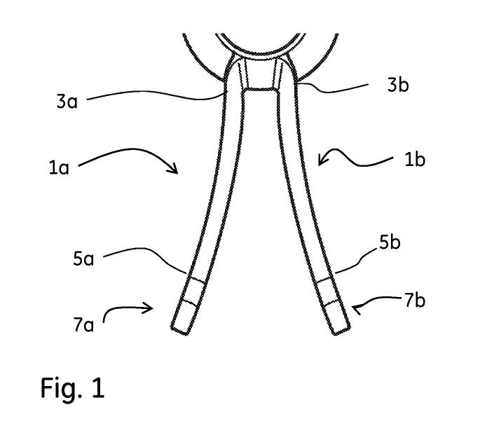

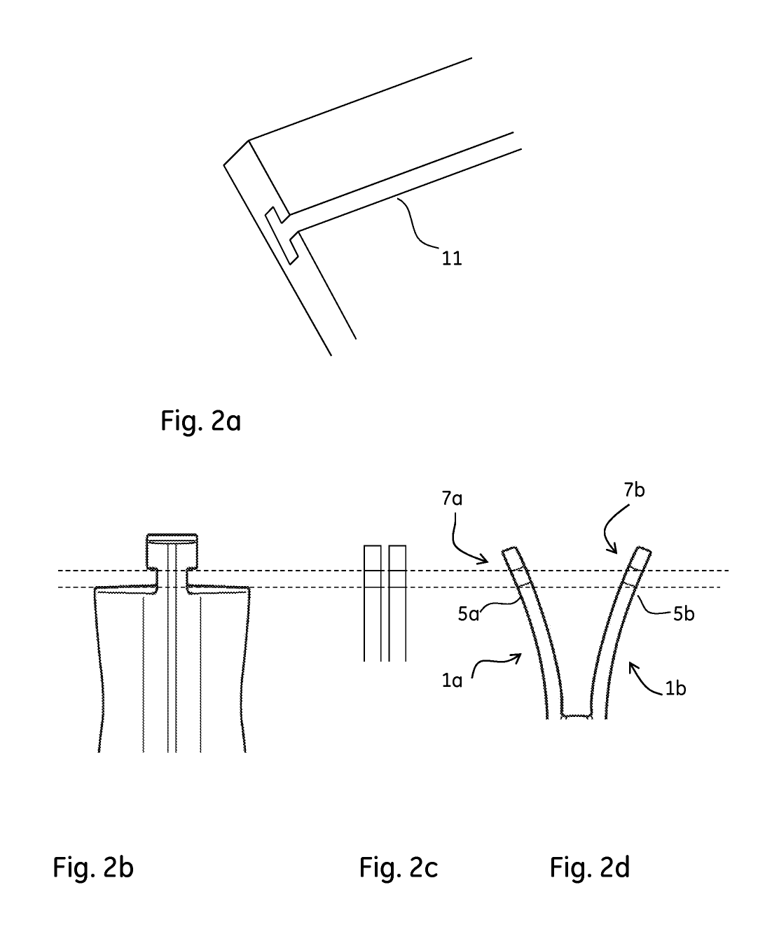

FIG. 1 is a schematic view of the attachment arrangement according to one embodiment of the invention. It comprises two resilient arms 1a, 1b. In this embodiment the resilient arms 1a, 1b are curved such that a first end 3a, 3b of the respective resilient arms 1a, 1b are positioned close to each other and a respective second end 5a, 5b of the resilient arms 1a, 1b are pointing away from each other. The first ends 3a, 3b of the resilient arms 1a, 1b are connected to whatever should be attached. Below is an example of a column holder. However it could be any kind of holder or it could also be attached directly to the thing to be hold. A locking part 7a, 7b is further provided at the second end 5a, 5b of each respective resilient arm 1a, 1b. This locking part 7a, 7b is T-shaped and adapted to fit into a T-groove where the attachment arrangement should be attached. The T-shape of the locking part is more clearly shown in FIGS. 2b, 3 and 4. According to the invention the two locking parts should be forced together and fit into the T-groove together as will be described in more detail below in relation to FIGS. 2a-2c.

In another embodiment the two resilient arms are not curved but they are provided close to each other in one end and pointing away from each other in the other end. Hereby they can be forced together during the insertion into the T-groove.

FIG. 2a-2d is a schematic view of the attachment arrangement according to the embodiment of the invention shown in FIG. 1 when it is inserted into a T-groove. FIG. 2a shows a typical T-groove 11 into which the attachment arrangement according to the invention can be inserted and secured. FIG. 2b shows schematically how the two resilient arms 1a, 1b are pressed together and oriented such that the T-shape of the locking parts 7a, 7b can be inserted into the T-groove 11. In FIG. 2c it is shown how the attachment arrangement is turned vertically inside the T-groove and in FIG. 2d it is shown how the pressure on the resilient arms 1a, 1b is released and that the second ends 5a, 5b of the resilient arms 1a, 1b then are pointing away from each other again. However the shape of the T-groove will limit the possibility for the second ends 5a, 5b of the resilient arms 1a, 1b to point away from each other. Hereby the T-shaped looking parts 7a, 7b will press against the T-groove and provide a locking and securing feature to the attachment arrangement. I.e. the attachment arrangement is hold securely in place in all directions due to the pressure from the resilient arms.

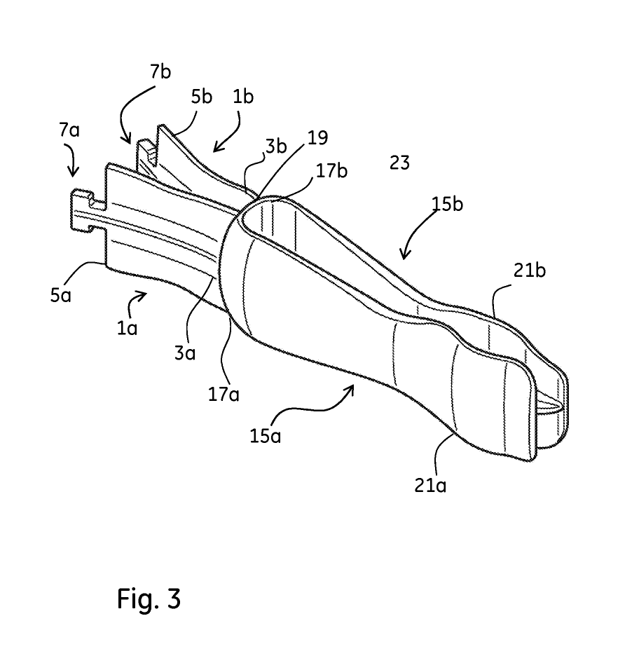

FIG. 3 shows one embodiment of a column holder provided with an attachment arrangement according to the invention. The same reference numbers as used in FIG. 1a are used for the attachment arrangement of the column holder shown in FIG. 3. This is here called a column holder but of course any kind of cylindrical objects can be hold by this device. The part of the column holder that is holding the column comprises two column grip arms 15a, 15b. The column grip arms 15a, 15b have a respective first end 17a, 17b where they are attached to each other and where also the attachment arrangement is provided. In this embodiment the first ends 17a, 17b of the column grip arms 15a, 15b are connected to each other through a bend 19. The column grip arms 15a, 15b are hereby pointing in the same direction and that is essentially the opposite direction to the direction in which the resilient arms 1a, 1b of the attachment arrangement are pointing. The column grip arms 15a, 15b further have a respective second end 21a, 21b. These second ends 21a, 21b are the column gripping part of the column grip arms 15a, 15b, i.e. between the second ends 21a, 21b of the column grip arms 15a, 15b a column is supposed to be provided. The column grip arms 15a, 15b are resilient and therefore the second ends 21a, 21b of the column grip arms 15a, 15b should be forced apart when a column is provided to the holder and then, when the force is removed the second ends 21a, 21b of the column grip arms 15a, 15b will press against the column and thereby hold it firmly. This design will allow the holding of different seizes of columns. Furthermore different seizes of column holders can also be provided in order to allow even more ranges of column seizes to be hold. In this design shown in FIG. 3 the column grip arms 15a, 15b are designed to comprise an intermediate part 23. This intermediate part 23 is provided to allow for a greater range of different column seizes and to minimize any deformation of the column gripping part, i.e. second ends 21a, 21b. In another embodiment of the invention however this intermediate part 23 can be omitted.

Suitably said column holder according to the first embodiment is injection moulded in one piece.

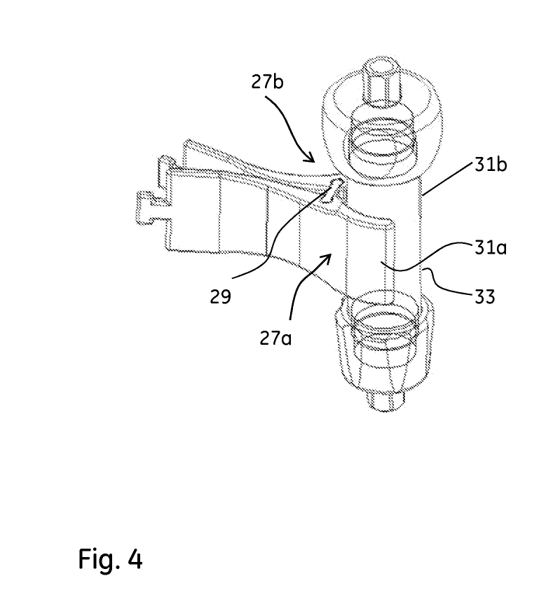

FIG. 4 shows another embodiment of a column holder provided with an attachment arrangement according to the invention. The same reference numbers as used in FIG. 1a are used for the attachment arrangement of the column holder shown in FIG. 4. The column holder comprises also here two column grip arms 27a, 27b. In this embodiment each of the column grip arms 27a, 27b is connected and suitably moulded in one piece together with one each of the resilient arms 1a, 1b of the attachment arrangement. Hereby, in this embodiment the column holder together with the attachment arrangement is comprised of only two pieces which can preferably each be injection moulded in one piece. The two parts are held together by a rubber hinge 29. The column grip arms 27a, 27b are designed in their column gripping parts 31a, 31b opposing the attachment arrangement to grip a column 33, i.e. they are slightly curved such that a column can fit in between the two column gripping parts 31a, 31b. The rubber hinge 29 is provided such that the two column gripping parts 31a, 31b can be forced to open up during insertion of columns and then grip the column after releasing. Furthermore columns of slightly different seizes can be hold by this column holder.

The material of the attachment arrangement and the column holder should preferably be resilient and not be weakened after long time deflection. This could for example be spring steel or plastics that are fatigue resistant.

Whilst the present invention has been described in connection with various embodiments, those skilled in the art will be aware that many different embodiments and variations are possible. All such variations and embodiments are intended to fall within the scope of the present invention as defined by the appended claims.

1. An attachment arrangement comprising:
two resilient arms (1a, 1b) connected in a respective first end (3a, 3b) of the resilient arms (1a, 1b) to a device to be attached, the respective second ends (5a, 5b) of the resilient arms (1a, 1b) pointing away from each other;
one locking part (7a, 7b) positioned in the second end (5a, 5b) of each resilient arm (1a, 1b), said locking parts (7a, 7b) being T-shaped and adapted to together fit into a T-groove by forcing the resilient arms (1a, 1b) towards each other and during insertion into the T-groove twist the attachment arrangement such that the T-shape of the locking parts (7a, 7b) fit into the T-groove and said attachment arrangement being secured in the T-groove when the attachment arrangement is twisted back again and the pressure on the resilient arms (1a, 1b) is released.

2. The attachment arrangement of claim 1, wherein the resilient arms (1a, 1b) are curved such that the second ends (5a, 5b) of the resilient arms (1a, 1b) are pointing away from each other.

3. A column holder comprising the attachment arrangement of claim 1.

4. The column holder of claim 3, wherein the whole column holder together with the attachment arrangement is injection moulded in one piece.

5. The column holder of claim 3, wherein a column holding part comprises two resilient column grip arms (15a, 15b).

6. The column holder of claim 3, further comprising an intermediate part connecting the column holding part (21a, 21b) of the column grip arms (15a, 15b) and the two resilient arms (1a, 1b), said intermediate part allowing the column holding part (21a, 21b) to hold even more ranges of columns of different seizes.

7. The column holder of claim 3, comprising two identical pieces each including a resilient arm (1) of the attachment arrangement and a column grip arm (15), said two identical pieces being connected by a rubber hinge (29) which is provided such that a column holding part (31a, 31b) can hold different sizes of columns steadily.
